(19) United States
(12) Patent Application Publication
(10) Pub. No.: US 2012/0156428 A1
(43) Pub. Date: Jun. 21, 2012

(54) CUSTOMIZED LABEL ASSEMBLY

(75) Inventor: Julie Eaton, Fortville, IN (US)

(73) Assignee: Multi Packaging Solutions, Inc., Lansing, MI (US)

(21) Appl. No.: 12/970,093

(22) Filed: Dec. 16, 2010

(51) Int. Cl. B32B 3/10; B32B 38/14; B32B 37/14; B32B 38/10; B32B 37/02; B32B 37/12

(52) U.S. Cl. 428/138; 156/249

(57) ABSTRACT

An improved advertising and labeling assembly and associated method is disclosed in which a composite structure is formed having multiple layers for forming a two-sided modifiable adhesive label.

### FIELD OF THE INVENTION

The present invention relates generally to labels and signage that can be easily and quickly customized and modified.

### BACKGROUND OF THE INVENTION

In the retail sector and elsewhere there is an ongoing and growing need for modifiable advertising and labeling systems. Any advertising and labeling systems that do not include digital functionality are generally static and must be removed and replaced or removed and substantially altered if any information on the label or advertisement requires modification. Generally, in order to modify some portion of a sign or advertisement, the sign or advertisement must be removed from its current location, modified as needed and then replaced. This requires additional labor and time and may also require that the sign or advertisement remain out of use for a period of time while it is modified. Often, an entirely new sign is purchased to replace the old sign when a change in information is required, resulting in increased expenditures. Most advertising and labeling systems also present challenges when movement is necessary as is commonly the case in retail environments where goods and associated advertisements and labeling are frequently moved depending on the season and particular store needs.

Notwithstanding the above, there remains a need for improved advertising and labeling systems that allow for simplified modification and movement while maintaining a low cost point. More particularly, there continues to be a need for advertising and labeling systems that can be modified repeatedly to reflect frequent changes in price or sale data while the label remains in use. There is a further need for advertising and labeling systems that can be repeatedly moved without the need for additional structures or adhering means.

### SUMMARY OF THE INVENTION

The present invention addresses one or more of the above needs by providing improved advertising and labeling assembly and associated methods in which a composite structure is formed having multiple layers for forming a two-sided modifiable adhesive label. For example, the label assembly may include a generally elongated and substantially planar adhesive label that includes a means for modifying the label without removing the label from a surface to which it is adhered. The means for modifying the label may include a cut-out portion extending through the adhesive label and a channel portion covering at least a portion of the cut-out portion. The channel portion may include a one-piece plastic planar sheet that is folded at one or more edges to receive a removable insert. The channel portion is configured so that the removable insert can be inserted, removed and replaced while the label assembly is adhered to a substrate. The label assembly may include one or more layers including a base layer, an adhesive layer and a handling layer.

In one aspect, there is contemplated a label assembly comprising a substantially planar base layer having a first surface and an opposing second surface and an adhesive layer having a top surface and an opposing bottom surface. The top surface of the adhesive layer may be located in planar contact with at least a portion of the second surface of the base layer. The label assembly may further include a handling layer located adjacent and in planar contact with the bottom surface of the adhesive layer. In order to facilitate simplified customization of the label assembly, a cut-out portion may extend through the base layer, the adhesive layer, and the handling layer, so that the cut-out portion includes a front face adjacent the first surface of the base layer and a back face adjacent the second surface of the base layer. One or more faces of the cut-out portion may be at least partially covered by a substantially transparent channel portion for receiving an insert. The channel portion may be attached to the first surface of the base layer and may cover at least a portion of the cut-out portion so that any contents within the channel can be viewed through the cut-out portion from either surface of the base layer. The channel portion may substantially cover the front face of the cut-out portion, but the back face of the cut-out portion may remain uncovered. The back face of the cut-out portion may also be covered by an additional channel portion.

The present invention also contemplates a method for providing an information label comprising the steps of providing a base layer including a first surface and an opposing second surface. The base layer may also include a cut-out portion extending through the base layer and a channel portion attached to the first surface of the base layer and covering at least a portion of the cut-out portion so that any contents within the channel can be viewed through the cut-out portion from either surface of the base layer. An adhesive layer having a top surface and a bottom surface may be placed in planar contact with the second surface of the base layer. A handling layer may then be placed in planar contact with the bottom surface of the adhesive layer so that the handling layer covers the area of the base portion adjacent the cut-out portion of the base layer, but does not cover the cut-out portion. A removable insert having a top surface and a bottom surface may be placed into the channel portion. The handling layer may be removed to reveal the adhesive layer and the base layer may then be adhered to a substantially transparent substrate via the adhesive layer. The base layer and removable insert may include printed material on the first and second surface of the base layer and the top and bottom surface of the removable insert so that the printed message on each side may then be viewed through the substantially transparent substrate. Alternatively, the label assembly may be adhered to a non-transparent substrate or any substrate where only one surface of the substrate is visible so that only one surface of the base layer may be viewed.

The label assembly described herein offers any of a number of benefits and advantages. The label assembly provides an easily modifiable advertising system wherein the label itself can be moved and re-used multiple times. Further, the removable insert portion of the label can be removed and replaced any number of times. In order to remove and replace the removable insert the label itself may remain in used and need not be removed from a surface to facilitate modification of the removable insert. The label assembly may also be adhered to a substantially transparent substrate so that the label can be viewed from either side of the substrate.

### BRIEF DESCRIPTION OF THE DRAWINGS

FIG. 1 is a cross-sectional view depicting the multiple substrate layers of an illustrative label assembly in accordance with the present teachings.

FIG. 2 is a cross-sectional view depicting the multiple substrate layers showing separation of one or more layers of an illustrative label assembly in accordance with the present teachings.

FIG. 3 is a perspective view of an illustrative label assembly in accordance with the present teachings.

FIG. 4 is a perspective view of the label assembly of FIG. 3 shown adhered to a substrate.

FIG. 5 is a back view of the label assembly of FIG. 3.

FIG. 6 is a perspective view of the label assembly of FIG. 3 shown with the removable insert removed.

FIG. 7 is a perspective view of the label assembly of FIG. 3 shown with a second removable insert.

### DETAILED DESCRIPTION

In general, the teachings herein provide for a label assembly that includes at least one or any combination of a base layer, an adhesive layer, a handling layer, a cut-out portion and a channel portion. The cut-out portion may extend through one or any combination of the base layer, the adhesive layer and the handling layer. The base layer may have first and second surfaces and may be in planar contact with one or more of the adhesive layer and the handling layer. The adhesive layer may be in planar contact with the second surface of the base layer. The handling layer may be in planar contact with the adhesive layer so that the adhesive layer is located between the base layer and the handling layer. The channel portion may be located so that it covers at least a portion of the cut-out portion.

The present invention further provides for a label assembly that includes an adhesive label having a first surface and a second opposing surface that can be customized and modified while in use by placing a removable insert within a channel portion of the label assembly. The label assembly may include printed material on both the first and second opposing surface of the base layer. The adhesive layer may permit the label assembly to be adhered to a first surface, removed from the first surface, and adhered to a second surface. The adhesive layer may permit transfer to a plurality of surfaces without a substantial reduction in adhesion strength of the adhesive layer. The channel portion may or may not be covered with the adhesive layer. The channel portion may be located on the first surface of the base layer, the second surface of the adhesive label, or both the first and second surface of the base layer.

The label assembly includes a base layer. The base layer may be substantially planar. The base layer includes a first surface and an opposing second surface. The base layer may include at least a portion that is substantially planar. The base layer may include a top edge, a bottom edge and one or more side edges. The base layer may include only three edges. The base layer may be circular, having only one edge. The top edge and bottom edge may be substantially parallel. The base layer may include a pair of substantially parallel side edges. The base layer may comprise a substantially continuous material layer. Alternatively, the base layer may include one or more cut-out portions. The base layer may be formed of a flexible material. The base layer may be formed of a substantially rigid material. The base layer may be formed of a flexible material having a coating or additional material layer placed thereon to impart increased rigidity to the base layer. As discussed further herein, the base layer may be contacted with an adhesive layer that may provide increased rigidity to the base layer material. The base layer may also be contacted with a handling layer so that the handling layer provides increased rigidity to the base layer.

The base layer may include one or more cut-out portions. The one or more cut-out portions may be formed by removing a portion of the base layer. The base layer material may be die-cut to remove a portion of the base layer, thus creating the cut-out portion. The one or more cut-out portions may be confined within the edges of the base layer so that the one or more cut-out portions do not contact any edges of the base layer. The cut-out portion may be formed so that a portion of the cut-out portion contacts one or more edges of the base layer so that an opening is created along one or more edges of the base layer. The cut-out portion may include one or more side edges. The cut-out portion may include at least two side edges that are substantially parallel to one another. The cut-out portion may include only one continuous side edge. The side edges of the one or more cut-out portions may be substantially parallel to one or more side edges of the base layer. Each side edge of the cut-out portion may be substantially parallel to a side edge of the base layer. The one or more cut-out portions may have four side edges, each side edge being substantially parallel to at least one side edge of the base layer. The length of each side edge of the one or more cut-out portions may be shorter than the length of any side edge of the base layer. The length of each side edge of the one or more cut-out portions may be shorter than the length of at least one side edge of the base layer. The shape of the cut-out portion may be similar to that of the base layer. For example, both the base layer and cut-out portion may both have a rectangular shape. Alternatively, the base layer and cut-out portion may have different shapes. As an example, the base layer may be rectangular in shape and the cut-out portion may be circular in shape. The cut-out portion may also encompass the majority of the base layer, so that only a small amount of base layer exists while the majority of the label assembly is comprised of the cut-out portion.

Each of the one or more cut-out portions includes a front face and a back face. The front face of the cut-out portion may be adjacent the first surface of the base layer, while the back face of the cut-out portion is adjacent the second surface of the base layer. The faces of the one or more cut-out portions may be covered by additional material layers that contact the base layer or that contact other additional material layers. As an example, one or both faces of the one or more cut-out portions may be covered by the handling layer. The one or more cut-out portions may be covered by the adhesive layer on one or more faces. One or more faces of the cut-out portion may remain exposed (e.g., uncovered) by any additional material layer.

The base layer may be contacted with an adhesive layer. The adhesive layer may allow the label assembly to adhere to a surface. The adhesive layer may be such that the label assembly can be adhered to a first surface, removed from the first surface, and adhered to a second surface and/or any number of additional surfaces. The adhesive layer may be a substantially permanent adhesive so that the label assembly is difficult to remove from a substrate, thus deterring theft of the label assembly. The adhesive layer may be located on the entire base layer. The adhesive layer may be located upon only a portion of the base layer. Alternatively, the base layer may include one or more mechanical fasteners for fastening the label assembly to a surface. The base layer may include no means for attachment, but may be placed onto a substrate that includes an adhesive or mechanical fastening means to attach the label assembly to the substrate.

Any adhesive layer may be contacted with a handling layer so that a tacky surface of the label assembly is not exposed prior to use. As an example, the handling layer may cover any portions of the base layer that are contacted by the adhesive layer. The handling layer may be flexible to allow for bending of the label assembly. The handling layer may be substantially planar. The handling layer may be placed in direct planar contact with the adhesive layer. The handling layer may also lie substantially parallel in relation to the base layer.

One or more faces of the cut-out portion may be covered by a channel portion. The channel portion may be formed so that it can receive an insert. The channel portion may be formed of a single continuous portion of material. The channel portion may be formed of multiple connected portions of material. The channel portion may include one or more folded edges. The one or more folded edges of the channel portion may be fastened to the base layer, the adhesive layer, the handling layer, or any material layer included within the label assembly. The one or more folded edges of the channel portion may be fastened to the base layer (or any material layer included within the label assembly) via an adhesive layer (e.g., adhesive tabs). The adhesive layer (e.g., adhesive tabs) may be located along the perimeter of the cut-out portion. The channel portion may be fastened via a mechanical fastener such as a pin, clip, staple or the like. The one or more folded edges may contact areas of the base layer that are adjacent (e.g., located at the perimeter of) the one or more cut-out portions.

The channel portion may include two folded edges so that two remaining edges are open and the open edges can receive the insert. The channel portion may be scored along the folded edges or at locations adjacent the folded edges to promote folding of the edges and prevent bowing of the channel portion. The scoring may be increased as the thickness of the intended insert decreases so that the folded edges form a thinner channel. Alternatively, the scoring may be reduced to receive inserts having increased thickness. One open edge may include a stopper or may be adhered or mechanically fastened to the base layer to further prevent an insert from becoming dislodged from the channel portion. The folded side edges may be formed as channels located along the top and bottom edges of the cut-out portion. The channels may thus receive an edge of an insert. Alternatively, the channel portion may also be formed of a continuous portion of material that is folded to form an envelope. The side edges of the envelope may be fastened (e.g., adhered) together so that the channel portion includes only one open edge for receiving a removable insert. The only one open edge may be the top edge or may be a side edge. The envelope formed may be large enough so that it can hold a plurality of coupons, brochures, or other informational material that can be retrieved by consumers or other individuals to which information should be supplied.

The removable insert may be planar so that it includes a top surface and a bottom surface. The top surface and bottom surface may include printed information so that the printed information can be viewed from both the first surface and second surface of the base layer. The printed information on the top surface and bottom surface of the removable insert may be identical. The removable insert may have a one or more side edges. The removable insert may have any shape or form so that it fits within the channel portion. The removable insert may include two substantially parallel side edges. The removable insert may include a top edge and a bottom edge. The top edge and bottom edge of the removable insert may be substantially parallel to one another. The lengths of each side edge and the top and bottom edge may correspond to the lengths of the channel portion so that the removable insert fits securely within the channel portion to prevent the removable insert from becoming unintentionally detached from the channel portion. The thickness of the removable insert may be such that the insert can slide into the channels created by the channel portion. However, the removable insert preferably has a thickness that prevents the insert from easily falling out of the channel portion during use.

The base layer and removable insert discussed herein may be composed of a pliable material to provide flexibility to the label assembly. A particular feature of the material may be that it is durable enough to resist tearing during attempts to place and remove the label assembly. The base layer and removable insert may be formed of the same material, or of different materials. The base layer and removable insert may be formed of paper materials including but not limited to paperboard, chipboard, cardboard, fiberboard, natural fibers, mineral fibers or any combination thereof. The material may be a virgin material, a post-consumer recycled material, or both. The material may be a recyclable material and/or a biodegradable material. If the base layer and/or removable insert material includes paperboard, the paperboard may be a bleached or unbleached paperboard. For example it may be a solid bleached sulfate (SBS) paperboard. The base layer and removable insert may be formed of a more rigid material, such as a polymeric material including but not limited to thermoplastics, thermoset plastics, elastomer containing materials or any combination thereof. Examples of polymeric materials that may be employed include polyamide, polyester, polystyrene, polyethylene (including polyethylene terephthlate, high density polyethylene and low density polyethylene), polypropylene, polyvinyl chloride, bio-based plastics/biopolymers (e.g., poly lactic acid), silicone, acrylonitrile butadiene styrene (ABS), or any combination thereof. The base layer and removable insert may also be composed of a paper-based material that includes a coating, which may be a polymeric coating, to enhance the strength and/or rigidity of the label assembly. The coating may be a film layer. Common plastic films that may be used include nylon, polyvinyl chloride, polypropylene, high-density polyethylene, low-density polyethylene, linear low-density polyethylene, polyvinylidene chloride and combinations thereof. The film layer may be any material with sufficient transparency for viewing information printed onto the base layer and/or removable insert.

The channel portion may be composed of any material having sufficient transparency so that any printed information located on the removable insert may be viewed through the channel portion. The channel portion may be formed of a more rigid material, such as a polymeric material including but not limited to thermoplastics, thermoset plastics, elastomer containing materials or any combination thereof. Examples of polymeric materials that may be employed include polyamide, polyester, polystyrene, polyethylene (including polyethylene terephthlate, high density polyethylene and low density polyethylene), polypropylene, polyvinyl chloride, bio-based plastics/biopolymers (e.g., poly lactic acid), silicone, nylon, acrylonitrile butadiene styrene (ABS), or any combination thereof.

The adhesive layer may include one or more adhesives for adhering at least a portion of base layer to a substrate. The adhesive may be capable of adhering to multiple types of substrates, including both rigid and flexible substrates. Such substrates may include, but are not limited to glass, polymeric materials, metal, paper-based materials, woven materials and the like. Suitable adhesives may include synthetic adhesives such as polymeric (e.g., thermoplastic, elastomeric, emulsion or thermosetting) adhesives. The adhesive may also include a bioadhesive such as starch, casein or albumin based adhesives. The adhesive may also include a UV curing adhesive. The adhesive may be a pressure sensitive adhesive such as a fugitive adhesive.

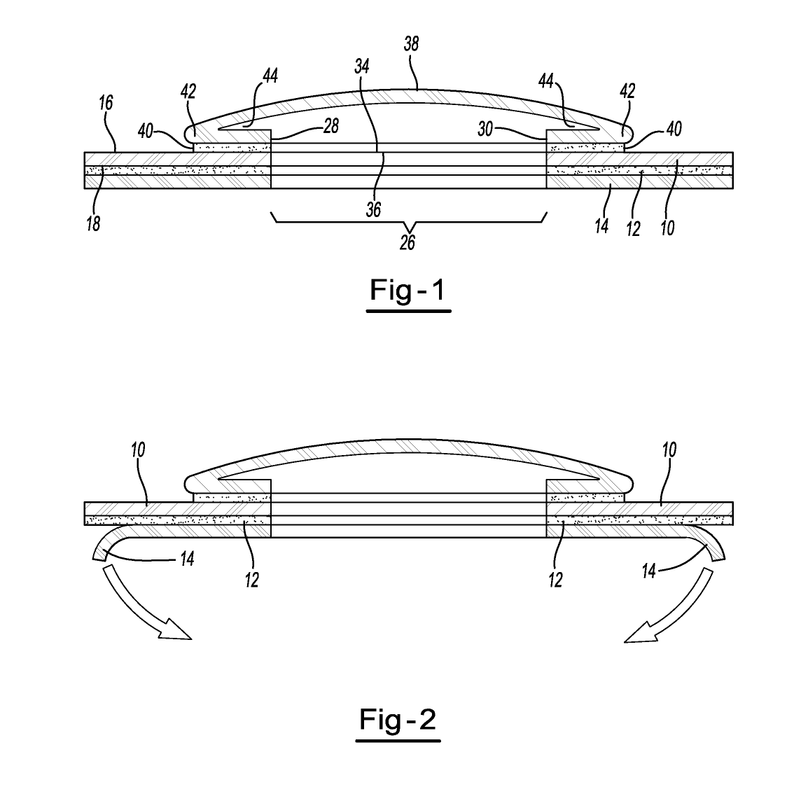

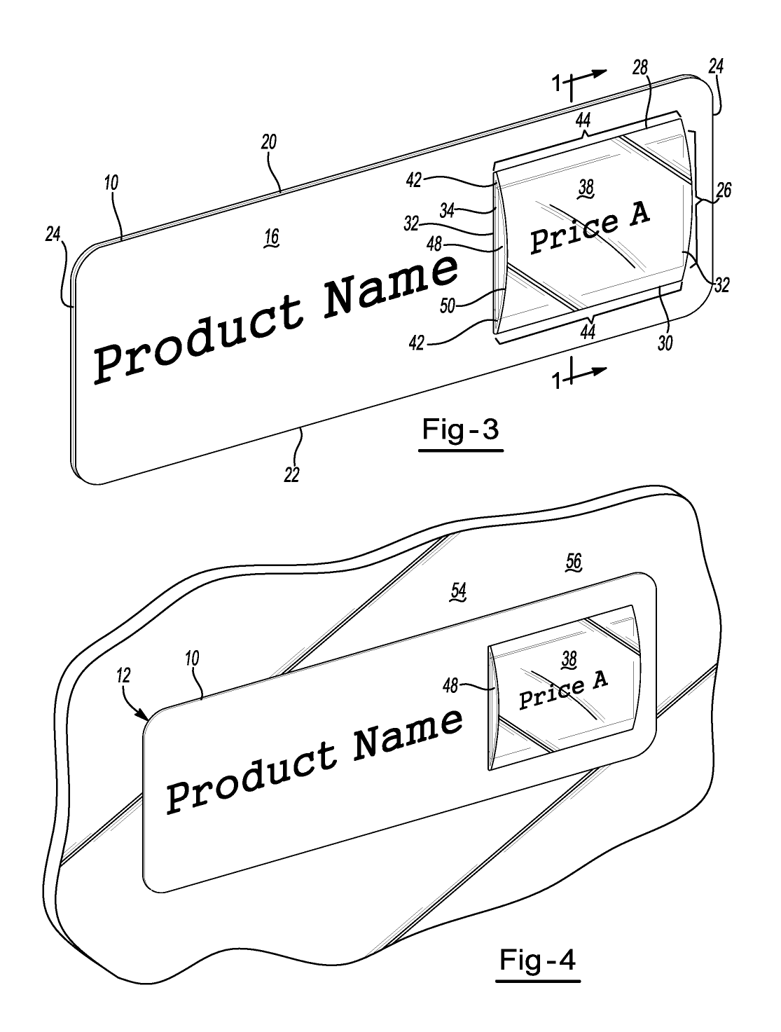

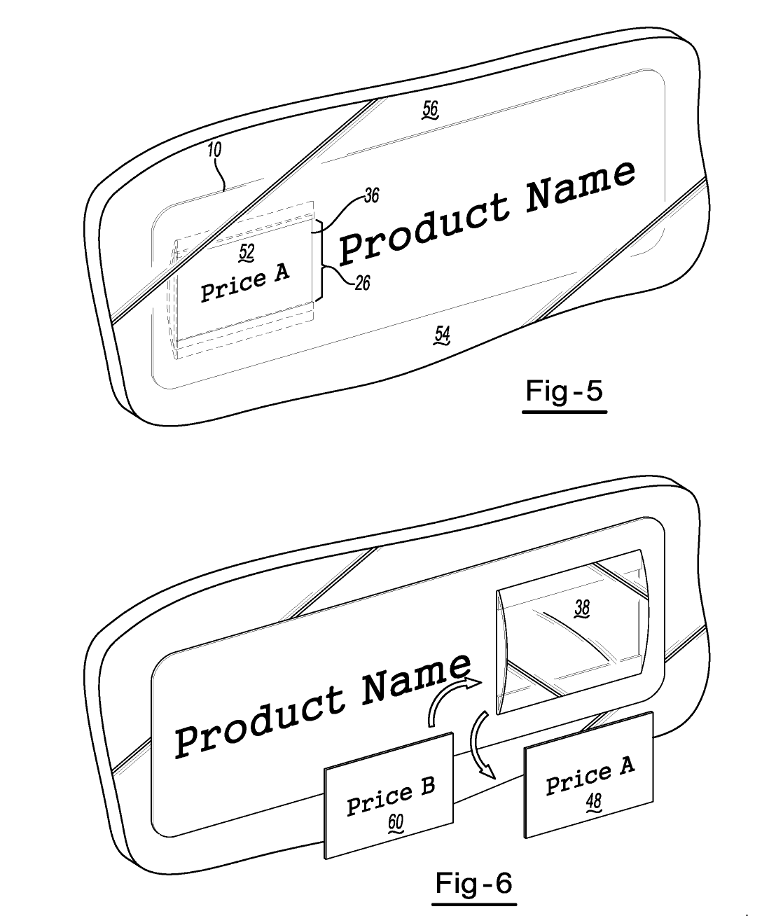

As shown for example in FIGS. 1 and 2, the label assembly may include a base layer 10, and adhesive layer 12, and a handling layer 14. The base layer 10 includes a first surface 16 and a second opposing surface 18. The base layer further includes a top edge 20, a bottom edge 22, and two substantially parallel opposing side edges 24 (shown at FIG. 3). A cut-out portion 26 may be located within the base layer 10. The cut-out portion 26 includes a top edge 28, a bottom edge 30 and two substantially parallel side edges 32 (shown at FIG. 3). The cut-out portion 26 includes a front face 34 and a back face 36 (shown at FIG. 5). The front face 34 of the cut-out portion may be covered with a channel portion 38. The channel portion 38 may be located onto the first surface 16 of the base layer 10 via adhesive tabs 40. The channel portion 16 includes two folded edge portions 42 that create channels 44 for receiving an insert (not shown). The adhesive layer 12 may be located in planar contact with the second surface 26 of the base layer 10. The handling layer 14 may be located in planar contact with the adhesive layer 12. As shown for example in FIG. 2, the handling layer 14 may be removed so that the adhesive layer 12 is exposed and the base layer 10 may be adhered to a substrate.

As shown in FIG. 3, the channel portion 38 is attached to the first surface 16 of the base layer 10. The channel portion 38 is composed of a single continuous transparent sheet 46 that includes two folded edge portions 42 that create channels 44 for receiving a removable insert 48. The removable insert has a top surface 50 and a bottom surface 52 (shown in FIG. 5). The top surface 50 of the removable insert 48 is arranged adjacent the first surface 16 of the base layer 10.

FIG. 4 shows the base layer 10 attached to a substrate 54 via the adhesive layer 12. The substrate may be a substantially transparent substrate having two opposing surfaces (a front surface 56 and a rear surface 58 (shown in FIG. 5)). Note that the removable insert 48 can be removed from within the channel portion 38 while the base portion 10 is adhered to the substrate 54. FIG. 5 shows the base layer 10 adhered to a substrate 54 as viewed from the rear surface 58 of the substrate 54. The back face 36 of the cut-out portion 26 remains uncovered and the bottom surface 52 of the removable insert 48 is visible and uncovered. Note that prior to removal of the handling layer, the back face of the cut-out portion 26 and bottom surface 52 of any removable insert 48 located within the channel portion 38 may not be covered by the handling layer.

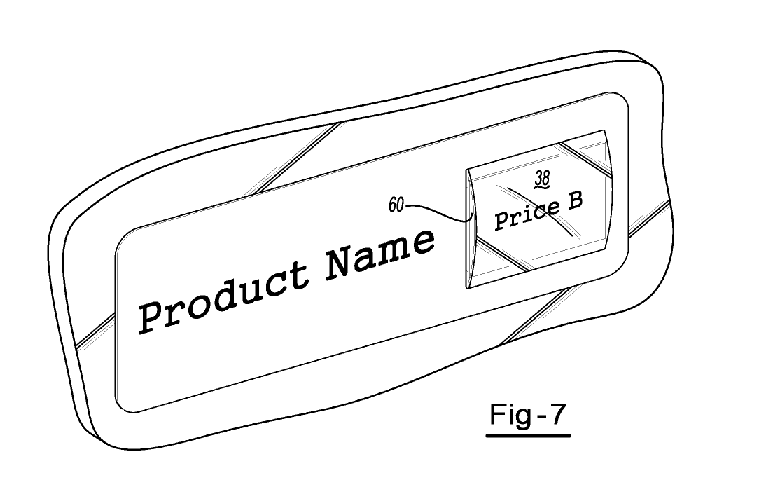

FIG. 6 shows the removal of the removable insert 48 from within the channel portion 38 so that a second removable insert 60 may be located within the channel portion 38 as shown in FIG. 7.

The label assembly may be shipped to the customer in one assembled piece, whereby an adhesive layer is included and the channel portion is already attached to the base layer. Alternatively, the label assembly may be shipped without an integrated adhesive layer, but may include a separate adhesive or mechanical fastener. The customer may provide a separate adhesive or mechanical fastener. The label assembly may be shipped to the customer in two pieces, whereby the channel portion is not attached to the base layer. Again, an adhesive or mechanical fastener may be provided to the customer for attaching the channel portion to the base layer or the customer may provide the adhesive or mechanical fastener for attaching the channel portion to the base layer.

The label assembly as disclosed herein provides a two-sided label assembly where the information can be frequently modified while the label is in use and the label can be viewed from two opposing surfaces of a transparent substrate during use. The label assembly may be beneficial in advertising or any other capacity where it is necessary to transmit information while still maintaining the ability to quickly modify the information as needed. The label assembly further provides such benefits at a minimal cost, whereas digital signage provides similar benefit at extremely high cost. The label assembly further provides a means to remove the assembly from one location and adhere the assembly to another location multiple times with little or no damage to the label assembly.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A label assembly comprising:
a substantially planar base layer having a first surface, an opposing second surface and at least one edge;
an adhesive layer having a top surface and an opposing bottom surface wherein the top surface of the adhesive layer is located in planar contact with at least a portion of the second surface of the base layer;
a handling layer located adjacent and in planar contact with the bottom surface of the adhesive layer;
a cut-out portion extending through the base layer, the adhesive layer, and the handling layer, having at least two opposing side edges so that the cut-out portion includes a front face adjacent the first surface of the base layer and a back face adjacent the second surface of the base layer;
a substantially transparent channel portion for receiving a label, the channel portion being attached to the first surface of the base layer and covering at least a portion of the cut-out portion so that any contents within the channel can be viewed within the cut-out portion from either surface of the base layer;
wherein the channel portion substantially covers the front face of the cut-out portion, but the back face of the cut-out portion remains uncovered.

2. The label assembly of claim 1, wherein the channel portion receives a substantially planar removable insert having a top surface and a bottom surface.

3. The label assembly of claim 2, wherein the top surface and bottom surface of the removable insert contain identical printed information.

4. The label assembly of claim 1, wherein the first surface and second surface of the base layer contain identical printed information.

5. The label assembly of claim 2, wherein the channel portion comprises two parallel channels formed parallel to at least one edge of the base layer so that the channels are formed to receive the removable insert located at opposing side edges of the cut-out portion.

6. The label assembly of claim 5, wherein the two parallel channels are substantially perpendicular to at least one edge of the base layer.

7. The label assembly of claim 1, wherein the channel portion is open on at least one side for insertion and removal of one or more removable inserts.

8. The label assembly of claim 1, wherein at least a portion of the base layer is formed of a polypropylene material.

9. The label assembly of claim 2, wherein the channel portion consists essentially of a one-piece plastic planar sheet that is folded at the edges of the channel portion that are parallel to the top edge and bottom edge of the base layer so that the folded edges are formed to receive the removable insert.

10. A method for providing an information label comprising the steps of:
providing a base layer including:
i. a first surface and an opposing second surface;
ii. a cut-out portion extending through the base layer;
adhering a channel portion to the first surface of the base layer that covers at least a portion of the cut-out portion so that any contents within the channel portion can be viewed through the cut-out portion from either surface of the base layer;
placing an adhesive layer having a top surface and a bottom surface in planar contact with the second surface of the base layer;
adhering a handling layer in planar contact with the bottom surface of the adhesive layer;
placing a removable insert having a top surface and a bottom surface into the channel portion;
removing the handling layer to reveal the adhesive layer;
adhering the base layer via the adhesive layer to a substantially transparent substrate so that both the base layer and the removable insert can be viewed through the transparent substrate.

11. The method of claim 10, including a step of printing onto the first surface and second surface of the base layer.

12. The method of claim 10, including a step of printing onto the removable insert.

13. The method of claim 12, including a step of printing identical information onto the top surface and bottom surface of the removable insert.

14. The method of claim 10, including a step of removing the removable insert and replacing the removable insert with a second removable insert.

15. The method of claim 10, including a step: of removing the base layer from the substantially transparent substrate and adhering the base layer onto a second substantially transparent substrate wherein no additional adhesive is required to adhere the base layer to the second substantially transparent substrate.

16. The method of claim 14, wherein the step of replacing the removable insert can be performed while the base layer remains adhered to a substrate.

17. A label assembly comprising:
a substantially planar base layer including:
i. a first surface;
ii. an opposing second surface;
iii. a top edge and substantially parallel bottom edge;
iv. two substantially parallel side edges;
an adhesive layer having a top surface and an opposing bottom surface wherein the top surface of the adhesive layer is located in planar contact with at least a portion of the second surface of the base layer;
a handling layer located adjacent and in planar contact with the bottom surface of the adhesive layer;
a cut-out portion extending through the base layer, the adhesive layer, and the handling layer, the cut-out portion including:
i. two substantially parallel side edges, wherein each side edge is also substantially parallel to one or more side edges of the base layer;
ii. a front face adjacent the first surface of the base layer;
iii. a back face adjacent the second surface of the base layer;
a substantially transparent channel portion for receiving a label, the channel portion being adhered to the first surface of the base layer and covering the front face of the cut-out portion so that any contents within the channel can be viewed within the cut-out portion from either surface of the base layer;
wherein the back face of the cut-out portion remains uncovered until the label assembly is adhered to a substantially transparent substrate whereby the substrate covers the back face of the cut-out portion and the back face of the cut-out portion can be viewed through the substantially transparent substrate.

18. The label assembly of claim 17, wherein the channel portion receives a substantially planar removable insert having a top surface and a bottom surface.

19. The label assembly of claim 18, wherein the channel portion consists essentially of a one-piece plastic planar sheet that is folded at two edges to receive the removable insert.

20. The label assembly of claim 19, wherein the folded edges of the plastic planar sheet form are parallel to the top edge and bottom edge of the base layer and are adhered to the first surface of the base layer via adhesive tabs placed along the perimeter of the cut-out portion.
